(19) United States
(12) Patent Application Publication
(10) Pub. No.: US 2008/0078067 A1
(43) Pub. Date: Apr. 3, 2008

(54) HANDLE

(76) Inventors: Aldo Di Nicolantonio, Recherswil (CH); Robert Simm, Oekingen (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/840,298

(22) Filed: Aug. 17, 2007

(30) Foreign Application Priority Data
Sep. 1, 2006 (DE) 10 2006 041 069.6
Jun. 21, 2007 (DE) 20 2007 008 670

(51) Int. Cl. E05B 1/00; B25B 23/16; B25G 1/00; A47B 95/02; B25G 1/04; A45F 5/10

(52) U.S. Cl. 16/426; 16/110.1; 81/177.2

(57) ABSTRACT

The invention describes a supplementary handle for a power tool, including a grip element and a clamping device for detachable fastening of the handle to a housing of a power tool, the clamping device including a clamping screw in such a way that by rotation of the grip element, the clamping device can be clamped to a housing of a power tool, and the grip element has at least a first axial partial element and a second axial partial element, and the first partial element is embodied rigidly relative to the clamping device, and the second partial element is embodied rotatably relative to the clamping device.

### REFERENCE TO FOREIGN PATENT APPLICATION

This application is based on German Patent Application No. 10 2006 041 069.6 filed 1 Sep. 2006, upon which priority is claimed.

### BACKGROUND OF THE INVENTION

1. Field of the Invention

The invention relates to a handle for a power tool, and more particularly to a supplementary handle for a power tool.

2. Description of the Prior Art

Numerous electric tools, such as right-angle sanders, power drills and drill hammers, are equipped with a supplementary handle. To prevent vibration that occurs in operation of the electric tool from being transmitted to the user via the supplementary handle, supplementary handles are usually provided with vibration-damping means.

From the prior art, supplementary handles are known which have a clamping device, such as a taut band or a clamping ring, for securing the supplementary handle to the housing of a power tool. For instance, in German Patent Disclosure DE 41 32 058 A1, a handle for handheld power tools is described that has a clamping ring. The clamping ring is clamped to a housing of a power tool by means of a screw. To that end, the screw thread is screwed into the grip sleeve of the handle, and the clamping ring contracts upon rotation of the grip sleeve.

For tightening and loosening the handle in DE 41 32 058 A1, the entire grip sleeve is accordingly used. This has the advantage that the user can exert major torque for tightening and loosening. On the other hand, a handle of this kind has the disadvantage that under certain conditions, such as major vibration in operation of the power tool, the handle may loosen by itself or in some other way unintentionally.

### SUMMARY OF THE INVENTION

The invention is based on a handle for a power tool, which includes a grip element and a clamping device for releasably securing the handle to a housing of a power tool. The clamping device has a clamping screw, which can be screwed into a receptacle in the grip element in such a way that by rotating the grip element, the clamping device can be clamped to a housing of a power tool.

According to the invention, the grip element has at least one first axial partial element and one second axial partial element. The two axial partial elements, disposed in contact with one another in the axial direction, together form the grip element that can be grasped by the user of the power tool. The first partial element is embodied rigidly relative to the clamping device, while the second partial element is embodied rotatably relative to the clamping device. Unlike in the handle known from the prior art, according to the invention it is not the entire grip element but only a partial element of the grip element that is embodied rotatably relative to the clamping device. For securing the handle to a housing of a power tool, it is therefore not the entire grip element that is rotated relative to the clamping device, but only the rotatably mounted partial element.

In a preferred embodiment, the first partial element is embodied as longer than the second partial element. In particular, the first, rigid partial element forms a grip element region that is oriented toward the clamping device. Conversely, the rotatable partial element is disposed on the end of the grip element facing away from the clamping device.

Dividing the grip element into one rigid and one rotatable partial element, and in particular a rigid longer partial element and a rotatable shorter partial element, has the advantage that the user's hand on grasping the grip element is holding the longer, rigid partial element. The handle according to the invention does not involve the risk that by simply grasping the grip element, the handle can come loose from the power tool. Unintentional loosening can thus be reliably prevented, since the user has to actuate the rotatable and in particular shorter partial element with enough force to loosen the handle from the power tool. If the handle according to the invention is used as a supplementary handle, it for instance prevents the following situation: The user of the power tool lets the main handle go with one hand, while with the other hand he continues to firmly hold the supplementary handle. In a supplementary handle of the prior art, it is then possible for the power tool to slip away and for the screw connection between the grip element and the clamping device to be undone. In the supplementary handle of the invention, this slipping, away of the power tool with simultaneous loosening of the screw connection is no longer possible, since the user is holding the rigid partial element firmly in his hand.

Especially preferably, the length of the first, rigidly embodied partial element amounts to at least two-thirds the length of the grip element. If the length of the rigid, first partial element amounts to essentially two-thirds, and the rotatable, second partial element essentially amounts to one-third of the total length of the grip element, then on the one hand adequate safety is attained, since the user's hand is essentially grasping the rigid partial element. If when the main handle is let go the power tool should slip and at that time be held only by the hand on the supplementary handle, there is no risk that the slippage will undo the screw connection between the clamping device and the grip element. On the other hand, a length of one-third for the second, rotatable partial element makes convenient and also sufficiently firm tightening of the grip element possible, since over this length, the user is capable of exerting a sufficiently high torque for tightening or loosening.

The clamping device of the handle of the invention preferably has a taut band. However, the clamping device may also be a one-piece or multiple-part clamping ring. This version of the clamping device will not be described further here, since it is not the subject of the invention. As an example, see DE 41 32 058 A1, in which a one-piece clamping ring is described. A two-part clamping ring is known for instance from German Utility Model DE 79 27 713 U1.

The handle according to the invention is especially suitable as a supplementary handle for a power tool, such as a power drill or drill hammer.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a power tool with a supplementary handle according to the invention;

FIG. 2 shows the supplementary handle with a taut band as its clamping device;

FIG. 3 is an exploded view showing partial components of a supplementary handle with a two-part clamping ring as the clamping device; and

FIG. 4 is a sectional view showing the supplementary handle of FIG. 3 in the installed state.

### DESCRIPTION OF THE PREFERRED EMBODIMENTS

In FIG. 1, a power tool 12 such as a power drill or percussion drill is shown. The power tool 12 includes a tool receptacle 52, which can be driven via a drive unit not shown in further detail, and a main handle 54 disposed on a side of the power tool 12 facing away from the tool receptacle 52. Along a bore axis 22 of the power tool 12, a supplementary handle 32 is disposed upstream in the axial direction 28 of the tool receptacle 52. The supplementary handle 32 represents a preferred embodiment of the handle of the invention. The supplementary handle 32 is located on a spindle neck 44 of the power tool 12. The supplementary handle 32 includes both a clamping device 10 and a grip element 65. By means of the clamping device 10, the supplementary handle 32 can be secured to the spindle neck 44 of the power tool 12.

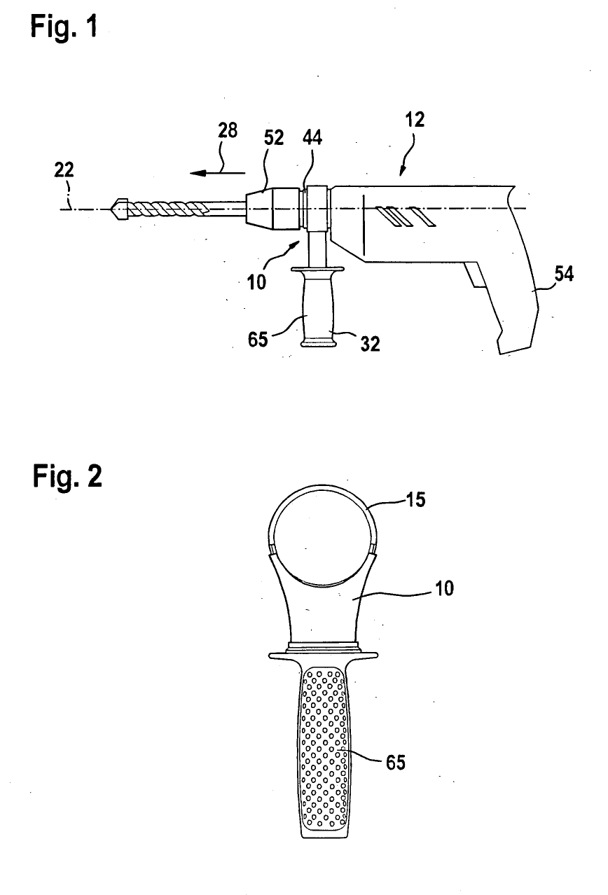

FIG. 2 shows as an example a supplementary handle 32 with a taut band 15 as its clamping device 10.

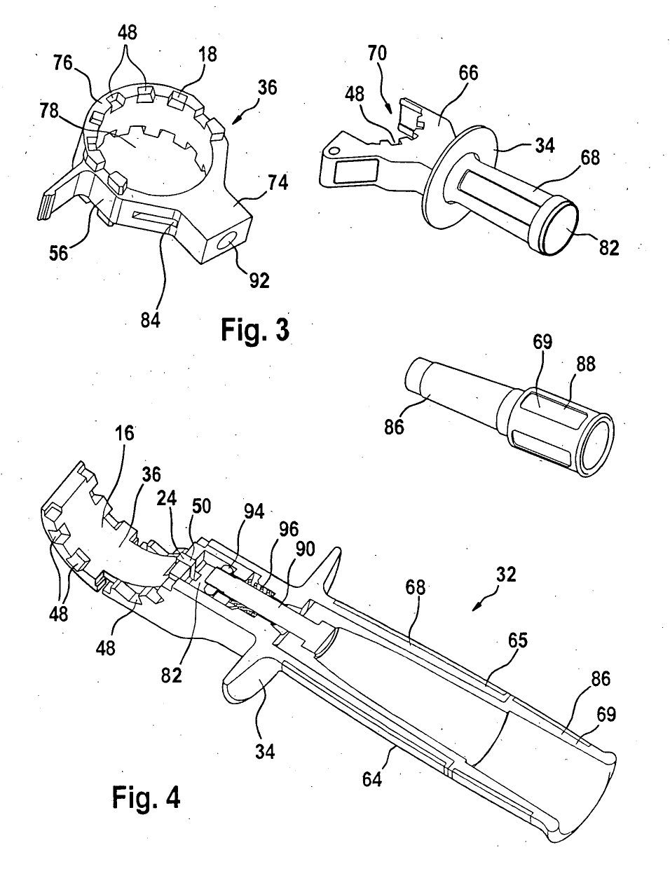

FIGS. 3 and 4 show a two-part clamping ring 16 as the clamping device 10; it includes a first component 34 and a second component 36. The invention will now be described in further detail in terms of the embodiment of FIGS. 3 and 4. The clamping device 10 has a fastening means 18 for attaining the positive-engagement connection in the circumferential direction of the fastening axis and a fastening means 24 for attaining a positive-engagement connection in the axial direction 28 of the fastening axis. Fastening means corresponding to the fastening means 18, 24 for attaining the positive-engagement connection in the circumferential direction of the fastening axis and the positive-engagement connection in the axial direction of the fastening axis are provided (not shown) on the spindle neck 44.

The first component 34 of the supplementary handle 32 includes a grip means 64 and a semicircular receiving means 66 for receiving the spindle neck 44 of the power tool. The receiving means 66 is embodied integrally with the grip means 64 and is open on a side facing away from the grip means 64. For securing the supplementary handle 32 to the spindle neck 44 of the power tool in the circumferential direction of the fastening axis, the receiving means 66 of the first component 34 has the fastening means 18. The fastening means 18 is formed by recesses 48, spaced uniformly apart from one another, that are disposed in the circumferential direction on a side of the receiving means 66 toward a receiving region 70. The recesses 48 extend along the fastening axis over a portion of the semicircular receiving means 66. For securing the supplementary handle 32 in the axial direction of the fastening axis, the receiving means 66 has the fastening means 24 for attaining a positive-engagement connection in the axial direction of the fastening axis, and this means is formed by a riblike fastening element 50 and is press-fitted into the receiving means 66. The riblike fastening element 50 embodied as a bolt protrudes into the semicircular receiving region 70 of the receiving means 66. A main lengthwise direction of the riblike fastening element 50 is oriented perpendicular to the fastening axis. The riblike fastening element 50 is formed by a stamped sheet-metal part.

The second component 36 includes a portion 74, which is intended for engagement with the inside of the first component 34, and a circular receiving means 76, for receiving the spindle neck 44 of the power drill and/or percussion power drill. The portion 74 and the circular receiving means 76 are embodied in one piece. The receiving means 76 forms a circular receiving region 78, which has a circle diameter that is equal to the circle diameter of the first component 34. The second component 36 has the fastening means 18 for attaining a positive-engagement connection in the circumferential direction. The recesses 48 extend along a portion 56 of the receiving means 76 of the second component 36 in the circumferential direction, and in the installed state, the portion 56 having the recesses 48 makes a transition to the recesses 48 of the first component 34.

For the positive interengagement of the first component 34 and the second component 36 of the supplementary handle 32, a portion surrounded by the grip means 64 of the first component 34 is provided with a hollow space on the inside (not shown) that is intended for receiving the second component 36. The second component 36 is embodied in slotted form in the portion 74, in a region of the receiving means 76 toward the portion 74, so that a positive engagement with the inside of the first component 34 is made possible. A slotted region 84 of the second component 36 is oriented perpendicular to the fastening axis. Upon mounting of the supplementary handle 32 on the spindle neck 44 of the power tool the second component 36 is introduced, perpendicular to the fastening axis and with the portion 74 leading, into the semicircular receiving region 70 and then into a hollow space 82 in the first component 34. In the process, the second component 36 is introduced so far into the first component 34 that essentially a complete circle diameter of the second component 36 is preserved. The circle diameter of the receiving region 78 is adapted to a cross section of the spindle neck 44, so that the supplementary handle 32 an be guided virtually without play on the spindle neck 44. In order to keep the second component 36 in position relative to the first component 34 as the supplementary handle 32 is being attached to the spindle neck 44, the first component 34 and the second component 36 are screwed together via a screw connection, not shown in detail.

For clamping the first component 34 to the second component 36, the supplementary handle 32 includes a third component 86. The first component 34 forms the first axial partial element 68, and the third component 86 forms the second axial partial element 69 of the grip element, so that the two partial elements 68, 69, disposed axially against one another, form the grip element 65. For that purpose, the third component 86 includes a grip means 88, which is introduced rotatably into the first component 34 and is screwed together with the second component 36 via a screw, threaded rod, or the like, that serves as a clamping screw 90. For that purpose, the portion 74 of the second component 36 includes a recess 92, with a nut 94 placed in the recess 92. The nut 94 has a torsion preventing means and is incorporated by positive engagement into a plastic wall of the portion 74 of the second component 36. In addition, in the hollow space 82 in the first component 34 there is a spring 96, which is disposed around the clamping screw 90 of the third component 86 and which is prestressed in the installed state of the supplementary handle 32. If by rotation of the third component 86 the screw connection with the second component 36 loosens, a spring force of the spring 96 causes the second component 36 to be forced out of the first component 34, causing the riblike fastening element 50 to come loose from the groovelike recess in the spindle neck 44, and the supplementary handle 32 can be removed from the spindle neck 44 of the power tool 12.

It can be seen from FIG. 4 that the first partial grip element 68 is embodied as longer than the second partial grip element 69, so that unintentional undoing of the screw connection is virtually impossible, since the user of the power tool, for using it in the conventional way, grasps the supplementary handle 32 with his whole hand over the entire length of the grip element 65. However, this means that the user's hand primarily grasps the first, longer axial partial element 68. Since the second axial partial element 69 forms the shorter partial element and is further disposed on the free end, oriented counter to the clamping device 10, of the grip element 65, only one or at most two fingers of the user's hand, and specifically the little finger and possibly the ring finger, grasp the second axial partial element 69. If the user wishes to undo the screw connection, he must instead grasp the grip means 88 or second partial grip element 69 and rotate it with sufficient force.

The foregoing relates to preferred exemplary embodiments of the invention, it being understood that other variants and embodiments thereof are possible within the spirit and scope of the invention, the latter being defined by the appended claims.

We claim:

1. A supplementary handle for a power tool the handle comprising a grip element and a clamping device for detachable fastening of the handle to a housing of a power tool, the clamping device including a clamping screw whereby by rotation of the grip element, the clamping device can be clamped to a housing of a power tool, the grip element having at least a first axial partial element and a second axial partial element, the first partial element being embodied rigidly relative to the clamping device, and the second partial element being embodied rotatably relative to the clamping device.

2. The handle as defined by claim 1, wherein the first partial element is embodied as longer than the second partial element.

3. The handle as defined by claim 2, wherein the length of the first partial element is at least two-thirds the length of the grip element.

4. The handle as defined by claim 1, wherein the clamping device comprises a taut band.

5. The handle as defined by claim 2, wherein the clamping device comprises a taut band.

6. The handle as defined by claim 3, wherein the clamping device comprises a taut band.

7. The handle as defined by claim 1, wherein the clamping device comprises a clamping ring.

8. The handle as defined by claim 2, wherein the clamping device comprises a clamping ring.

9. The handle as defined by claim 3, wherein the clamping device comprises a clamping ring.

10. A power tool having a supplementary handle as defined by claim 1.

11. A power tool having a supplementary handle as defined by claim 2.

12. A power tool having a supplementary handle as defined by claim 3.

13. A power tool having a supplementary handle as defined by claim 4.

14. A power tool having a supplementary handle as defined by claim 7.
